(19) United States
(12) Patent Application Publication
(10) Pub. No.: US 2009/0000007 A1
(43) Pub. Date: Jan. 1, 2009

(54) NONWOVEN RADIOPAQUE MATERIAL FOR MEDICAL GARMENTS AND METHOD FOR MAKING SAME

(75) Inventor: Ronald F. DeMeo, Miami, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Meridian Research and Development, Inc., Fort Lauderdale, FL (US)

(21) Appl. No.: 12/125,304

(22) Filed: May 22, 2008

Related U.S. Application Data
(63) Continuation-in-part of application No. 11/019,952, filed on Dec. 20, 2004.
Application No. 11/019,952 is a division of application No. 10/620,954, filed on Jul. 16, 2003, now Pat. No. 6,841,791.
Application No. 10/620,954 is a continuation-in-part of application No. 10/238,160, filed on Sep. 9, 2002, now Pat. No. 6,828,578.
Application No. 10/238,160 is a continuation-in-part of application No. 09/940,681, filed on Aug. 27, 2001, now Pat. No. 6,459,091.
Application No. 09/940,681 is a continuation-in-part of application No. 09/206,671, filed on Dec. 7, 1998, now Pat. No. 6,281,515.

(51) Int. Cl. A41D 10/00; B29C 47/00; A41D 13/12; B32B 5/02

(52) U.S. Cl. 2/83; 442/62; 264/176.1; 2/114

(57) ABSTRACT

The present invention provides a breathable, lightweight material which has radiopaque qualities and is easy to produce. In the preferred embodiment, a lightweight fabric, such as a surgical mask liner or an entire surgical gown, is formed by mixing a lightweight radiopaque compound, such as barium sulfate, with a polymer filler, preferably polyethylene, to impart radiopaque qualities to the mixture, then extruding the mixture into a plurality of filaments to form a porous, nonwoven fabric mass, and forming the filament mass into a web suitable to be used as a garment liner or ply in a multi-ply fabric.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates primarily to garments which can protect the wearer against the hazards of exposure to radiation. More particularly, the present invention relates to breathable, lightweight garments containing radiopaque compounds, such as barium sulfate, that are particularly suitable for use by medical professionals and patients who are exposed to radiation from medical x-rays.

It is very common in medicine today to use x-rays for diagnostic and therapeutic purposes. While these x-rays serve a beneficial medical purpose, they can also have harmful side effects for both the patient to whom the x-rays are directed and the medical workers who must administer x-rays on a day-to-day basis.

There have been a number of previous attempts to mitigate the harmful effects of x-rays through the design of radiopaque protective garments. Typically, these radiopaque garments consist of a stiff material, such as rubber, impregnated by lead or some other heavy metal which is capable of blocking x-rays. Examples of lead impregnated radiopaque garments can be found in Holland's U.S. Pat. No. 3,052,799, Whittaker's U.S. Pat. No. 3,883,749, Leguillon's U.S. Pat. No. 3,045,121, Via's U.S. Pat. No. 3,569,713 and Still's U.S. Pat. No. 5,038,047.

While the lead filled prior art garments provide a good measure of protection against the harmful effects of x-rays, these prior art garments are often heavy, stiff, expensive, bulky and lacking in breathability. As such, these garments are often uncomfortable, cumbersome and restrictive. Also, there are sterility issues with these prior art garments because they are typically too bulky and expensive to dispose of after each use.

### BRIEF SUMMARY OF THE INVENTION

The present invention provides a breathable, lightweight material which has radiopaque qualities and is easy to produce. In the preferred embodiment, a lightweight fabric, such as a surgical mask liner or an entire surgical gown, is formed by mixing a lightweight radiopaque compound, such as barium sulfate, with a polymer filler, preferably polyethylene, to impart radiopaque qualities to the mixture, then extruding the mixture into a plurality of interwoven filaments to form a porous, nonwoven fabric mass, and forming the filament mass into a sheet suitable to be used as a garment liner or ply in a multi-ply fabric.

Formation of nonwoven material may be effected for example by means of a spinning multiple-nozzle extrusion head, called a spinneret, containing as few as 40 nozzle holes to as many as a thousand nozzle holes, then the mass of spun filaments is then subjected to rollers or other joining and shaping processes to flatten and spread into a nonwoven, breathable fabric and continuous textile web. Impregnation of the lightweight radiopaque compound can be performed in any number of ways including soaking the fabric in a solution containing the lightweight radiopaque compound, using the fabric as a filter for a passing solution containing the lightweight radiopaque compound, placing the fabric in a reaction chamber between reagents that can react to form the lightweight radiopaque compound and creating the fabric incorporating one radiopaque compound reagent and then exposing it to a complementary reagent used to form the radiopaque compound.

Besides barium sulfate, other radiopaque substances which can be used for the present invention include, but are not limited to, barium particles, HYPAQUE™ (which is a tradename of Nycomed Corporation for Diatrizoate Meglumine Inj USP), Acetrizoate Sodium, Bunamiodyl Sodium, Diatrizoate Sodium, Ethiodized Oil, Iobenzamic Acid, Iocarmic Acid, Iocetamic Acid, Iodipamide, Iodixanol, Iodized Oil, Iodoalphionic Acid, o-Iodohippurate Sodium, Iodophthalein Sodium, Iodopyracet, Ioglycamic Acid, Iohexol, Iomeglamic Acid, Iopamidol, Iopanoic Acid, Iopentol, Iophendylate, Iophenoxic Acid, Iopromide, Iopronic Acid, Iopydol, Iopydone, Iothalamic Acid, Iotrolan, Ioversol, Ioxaglic Acid, Ioxilan, Ipodate, Meglumine Acetrizoate, Meglumine Ditrizoate Methiodal Sodium, Metrizamide, Metrizoic Acid, Phenobutiodil, Phentetiothalein Sodium, Propryliodone, Sodium Iodomethamate, Sozoiodolic Acid, Thorium Oxide and Trypanoate Sodium, and other metal salts, such as bismuth salts and uranium salts, antimony, and tungsten, complexed with a polymer.

While a surgical mask is provided as one example, the principles of the invention can also be applied to a broad range of other garments including hoods, gowns, gloves, patient drapes, partitions, coverings, etc.

### BRIEF DESCRIPTION OF THE DRAWINGS

FIG. 1 shows a doctor wearing a surgical mask of the present invention.

FIG. 2 shows a cutaway, perspective view of the surgical mask from FIG. 1.

FIG. 3 shows a cross-sectional view of the surgical mask from FIGS. 1 and 2.

FIG. 4 is one embodiment of an apparatus for fabricating nonwoven radiopaque webs.

FIG. 5 is an illustration of a surgical gown.

### DETAILED DESCRIPTION OF THE INVENTION

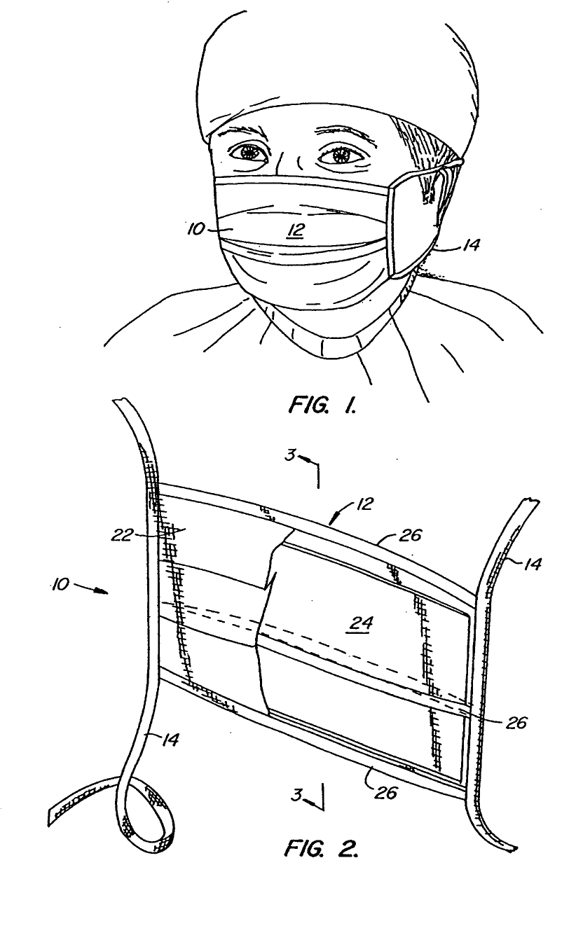

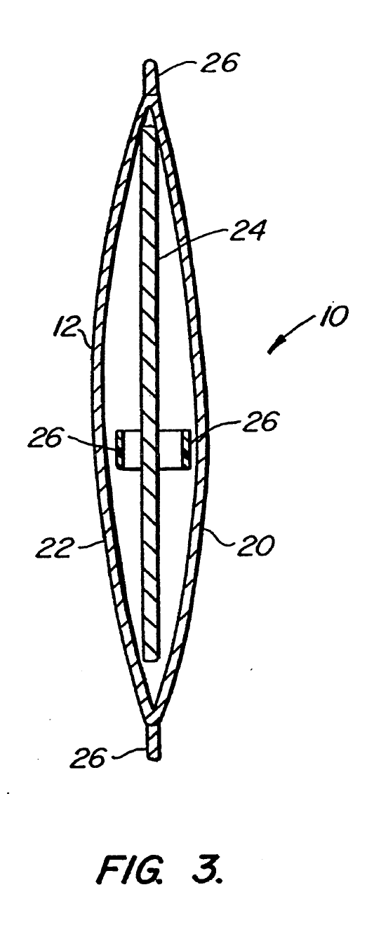

FIG. 1 shows a surgeon wearing a surgical mask 10 of the present invention. The surgical mask 10 has a facial portion 12 which covers the surgeon's mouth and nose as well as straps 14 which holds the surgical mask 10 onto the surgeon's face. As shown in FIGS. 2 and 3, the facial portion 12 of the surgical mask is primarily made up of three plies: an interior ply 20 situated next to the surgeon's face, an exterior ply 22 situated on the outside of the mask and a central liner 24. In its common, disposable form, the interior 20 and exterior 22 plies of the surgical mask 10 are made of paper and the central liner 24 is made of a breathable cloth material, such as a radiopaque nonwoven web. Plastic or metal stays 26 are typically provided at the top, bottom and middle of the surgical mask 10 to help the surgical mask 10 retain its shape and enhance its seal.

As described thus far, the surgical mask 10 shown in FIGS. 1-3 is of conventional construction. A distinguishing aspect of the present invention is inexpensively imparting radiopaque qualities to such a surgical mask 10 without significantly diminishing its lightweight usability.

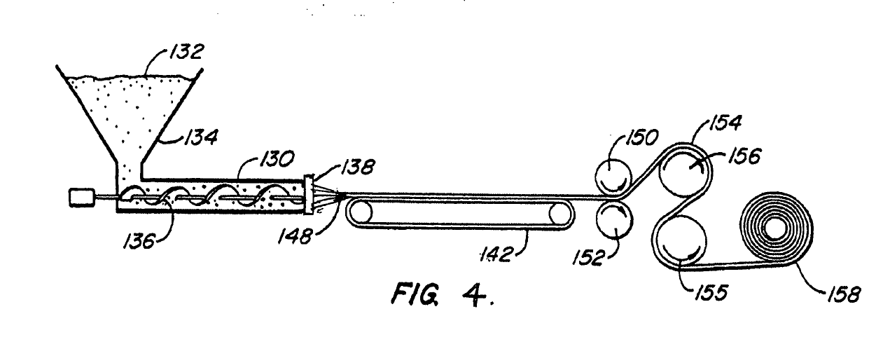

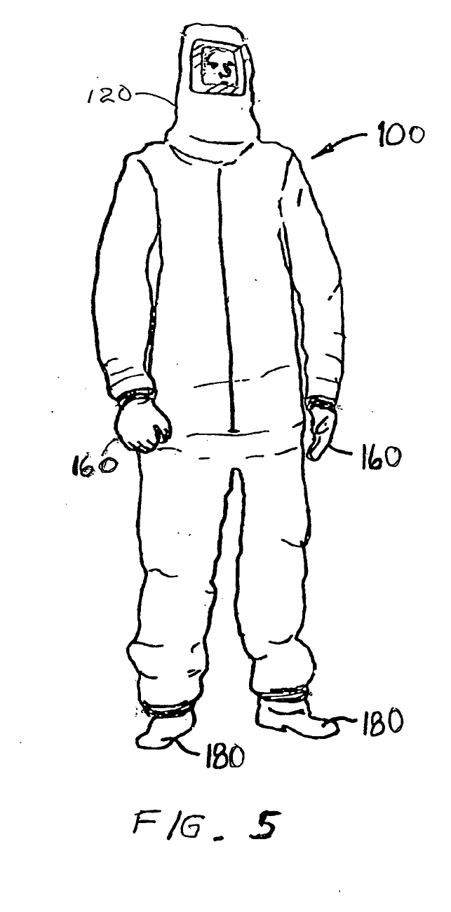

The surgical mask of the present invention can be given radiopaque qualities by, prior to assembly, extruding and flatting the extrusion into a web to serve as its liner 24 that is made from a lightweight radiopaque element or compound, such as barium, barium sulfate, or the reagents used to form the lightweight radiopaque compound, such as barium chloride mixed with a polymer, such as polyethylene, to form a barium sulfate lightweight radiopaque compound in suspension in polyethylene. Other suitable polymers are ethyl vinyl acetate, polyethylene, polyurethane, polyamide, polyvinyl chloride, polyvinyl alcohol, natural latex, polypropylene and polyester. As shown in FIG. 4, the mixture 132 is placed in a hopper 134, fed into an extruder 130 and is extruded by an extrusion screw 136 through an extrusion head, such as a multiple-port spinning head 138 called a spinneret into a continuous filament mass 148 and flattened or rolled by rollers 150, 152 or otherwise formed into a porous, breathable web 158 as shown in FIG. 4 for use as the liner 24.

The breathable radiopaque liner 24 can then be placed between interior 20 and exterior 24 plies and sewn or sealed into the surgical mask 10 in a manner that is well known in the art. Since the radiopaque material is capable of blocking x-rays, the liner of radiopaque material placed into a surgical mask liner 24 gives an otherwise conventionally constructed surgical mask 10 the ability to block x-rays from harming the surgeon's face while still allowing breathability.

Barium sulfate is a preferred radiopaque precipitate for the present invention because, as compared with lead for example, it is lighter in weight, inexpensive, promotes breathability and has fewer known health hazards. Other lightweight radiopaque compounds can also used to form filaments and fabric for the present invention in a manner similar to that already described. These other lightweight radiopaque compounds include but are not limited to, a substance containing at least one of barium, bismuth, tungsten, iodine, antimony, copper, and uranium, including barium particles and bariums salts, bismuth, tungsten and iodine compounds, HYPAQUE™, Acetrizoate Sodium, Bunamiodyl Sodium, Diatrizoate Sodium, Ethiodized Oil, Iobenzamic Acid, Iocarmic Acid, Iocetamic Acid, Iodipamide, Iodixanol, Iodized Oil, Iodoalphionic Acid, o-Iodohippurate Sodium, Iodophthalein Sodium, Iodopyracet, Ioglycamic Acid, Iohexol, Iomeglamic Acid, Iopamidol, Iopanoic Acid, Iopentol, Iophendylate, Iophenoxic Acid, Iopromide, Iopronic Acid, Iopydol, Iopydone, Iothalamic Acid, Iotrolan, Ioversol, Ioxaglic Acid, Ioxilan, Ipodate, Meglumine Acetrizoate, Meglumine Ditrizoate Methiodal Sodium, Metrizamide, Metrizoic Acid, Phenobutiodil, Phentetiothalein Sodium, Propryliodone, Sodium Iodomethamate, Sozoiodolic Acid, Thorium Oxide and Trypanoate Sodium. These radiopaque compounds for the present invention can be purchased from a variety of chemical supply companies such as Fisher Scientific, P.O. Box 4829, Norcross, Ga. 30091 (Telephone: 1-800-766-7000), Aldrich Chemical Company, P.O. Box 2060, Milwaukee, Wis. (Telephone: 1-800-558-9160) and Sigma, P.O. Box 14508, St. Louis, Mo. 63178 (Telephone: 1-800-325-3010).

Thus far, techniques have been described for imparting radiopaque qualities into a garment through impregnation with lightweight chemical compounds. As herein described, the radiopaque material is formed into filaments and made into a nonwoven fabric to provide both the flexibility and breathability of a cloth garment and the x-ray protection of a metallic garment, as for example illustrated by the full body gown 100, hood 120, gloves 160 and booties 180 of FIG. 5. The radiopaque material could also be added to a variety of plastics, polymers or glass to create, for example, a clear eye shield with radiopaque qualities.

In the foregoing specification, the invention has been described with reference to specific preferred embodiments and methods. It will, however, be evident to those of skill in the art that various modifications and changes may be made without departing from the broader spirit and scope of the invention as set forth in the appended claims. The specification and drawings are, accordingly, to be regarded in an illustrative, rather than restrictive sense; the invention being limited only by the appended claims.

What is claimed is:

1. A breathable, radiation protective fabric material comprising a polymer and a lightweight radiopaque substance extruded as filaments and formed into a breathable fabric.

2. The fabric material according to claim 1 wherein said radiopaque substance is barium and said polymer is polyethylene.

3. The fabric material according to claim 2 wherein said extruded filaments are formed into a nonwoven fabric as said breathable fabric.

4. The fabric material according to claim 3 wherein said extruded filaments are spunbond into said nonwoven fabric.

5. The fabric material according to claim 1 wherein said extruded filaments are formed as a nonwoven fabric.

6. The fabric material according to claim 5 wherein said radiopaque substance contains barium.

7. The fabric material according to claim 6 wherein said extruded filaments are spunbond and formed into said nonwoven fabric.

8. The fabric material of claim 1 wherein said lightweight radiopaque substance is selected from the group consisting of barium sulfate, barium and barium salts, wherein said polymer is polyethylene and wherein said extruded filaments are spunbond as a nonwoven mass and formed into said breathable fabric.

9. A hospital garment with radiopaque qualities comprising a breathable radiation protective fabric formed of a polymer and a lightweight radiopaque substance extruded as filaments and formed into a breathable fabric, then inserted as a liner between layers.

10. The hospital garment according to claim 9 wherein said extruded filaments are formed into a nonwoven fabric as said breathable fabric.

11. The hospital garment of claim 10 wherein said lightweight radiopaque substance contains barium.

12. The hospital garment of claim 10 wherein said polymer is polyethylene.

13. The hospital garment of claim 10 wherein said filaments are spunbond.

14. The hospital garment of claim 14 wherein said garment is a surgical mask.

15. The hospital garment of claim 14 wherein said garment is a gown.

16. The hospital garment of claim 14 wherein said garment is a patient drape.

17. A method for creating a breathable garment with radiopaque qualities comprising the steps of:
mixing a lightweight radiopaque substance which is particulate with a polymer to form a mixture;
extruding said mixture through an extruder to obtain filaments;
forming said filaments into a web of a breathable fabric; and
using said breathable fabric web to construct a breathable garment with radiopaque qualities.

18. The method of claim 17, wherein said extrusion is of the spunbond type.

19. The method according to claim 18 wherein said polymer is polyethylene and said radiopaque substance contains barium.

20. The method according to claim 18 wherein said radiopaque substance comprises a substance containing at least one of barium, bismuth, tungsten, iodine, antimony, copper, and uranium.

21. The method according to claim 18 wherein said radiopaque substance is selected from the group consisting of Diatrizoate Meglumine Inj USP, Acetrizoate Sodium, Bunamiodyl Sodium, Diatrizoate Sodium, Ethiodized Oil, Iobenzamic Acid, Iocarmic Acid, Iocetamic Acid, Iodipamide, Iodixanol, Iodized Oil, Iodoalphionic Acid, o-Iodohippurate Sodium, Iodophthalein Sodium, Iodopyracet, Ioglycamic Acid, Iohexol, Iomeglamic Acid, Iopamidol, Iopanoic Acid, Iopentol, Iophendylate, Iophenoxic Acid, Iopromide, Iopronic Acid, Iopydol, Iopydone, Iothalamic Acid, Iotrolan, Ioversol, Ioxaglic Acid, Ioxilan, Ipodate, Meglumine Acetrizoate, Meglumine Ditrizoate Methiodal Sodium, Metrizamide, Metrizoic Acid, Phenobutiodil, Phentetiothalein Sodium, Propryliodone, Sodium Iodomethamate, Sozoiodolic Acid, Thorium Oxide and Trypanoate Sodium.

22. The fabric material according to claim 5 wherein said polymer in said radiation protective polymeric mixture is selected from the group consisting of ethyl vinyl acetate, polyethylene, polyurethane, polyamide, polyvinyl chloride, polyvinyl alcohol, natural latex, polypropylene and polyester.

23. The fabric material according to claim 5 wherein said radiopaque substance is selected from the group consisting of Diatrizoate Meglumine Inj USP, Acetrizoate Sodium, Bunamiodyl Sodium, Diatrizoate Sodium, Ethiodized Oil, Iobenzamic Acid, Iocarmic Acid, Iocetamic Acid, Iodipamide, Iodixanol, Iodized Oil, Iodoalphionic Acid, o-Iodohippurate Sodium, Iodophthalein Sodium, Iodopyracet, Ioglycamic Acid, Iohexol, Iomeglamic Acid, Iopamidol, Iopanoic Acid, Iopentol, Iophendylate, Iophenoxic Acid, Iopromide, Iopronic Acid, Iopydol, Iopydone, Iothalamic Acid, Iotrolan, Ioversol, Ioxaglic Acid, Ioxilan, Ipodate, Meglumine Acetrizoate, Meglumine Ditrizoate Methiodal Sodium, Metrizamide, Metrizoic Acid, Phenobutiodil, Phentetiothalein Sodium, Propryliodone, Sodium Iodomethamate, Sozoiodolic Acid, Thorium Oxide and Trypanoate Sodium.

24. The fabric material according to claim 1 wherein said polymer in said radiation protective polymeric mixture is selected from the group consisting of ethyl vinyl acetate, polyethylene, polyurethane, polyamide, polyvinyl chloride, polyvinyl alcohol, natural latex, polypropylene and polyester.

25. The fabric material according to claim 1 wherein said radiopaque substance is selected from the group consisting of Diatrizoate Meglumine Inj USP, Acetrizoate Sodium, Bunamiodyl Sodium, Diatrizoate Sodium, Ethiodized Oil, Iobenzamic Acid, Iocarmic Acid, Iocetamic Acid, Iodipamide, Iodixanol, Iodized Oil, Iodoalphionic Acid, o-Iodohippurate Sodium, Iodophthalein Sodium, Iodopyracet, Ioglycamic Acid, Iohexol, Iomeglamic Acid, Iopamidol, Iopanoic Acid, Iopentol, Iophendylate, Iophenoxic Acid, Iopromide, Iopronic Acid, Iopydol, Iopydone, Iothalamic Acid, Iotrolan, Ioversol, Ioxaglic Acid, Ioxilan, Ipodate, Meglumine Acetrizoate, Meglumine Ditrizoate Methiodal Sodium, Metrizamide, Metrizoic Acid, Phenobutiodil, Phentetiothalein Sodium, Propryliodone, Sodium Iodomethamate, Sozoiodolic Acid, Thorium Oxide and Trypanoate Sodium.
